(19) United States
(12) Patent Application Publication
(10) Pub. No.: US 2018/0012688 A1
(43) Pub. Date: Jan. 11, 2018

(54) LAMINATED ELECTRONIC COMPONENT

(71) Applicant: Murata Manufacturing Co., Ltd., Kyoto (JP)

(72) Inventors: Yutaka NOGUCHI, Nagaokakyo-shi (JP); Makoto YAMAMOTO, Nagaokakyo-shi (JP); Takeshi KOBAYASHI, Nagaokakyo-shi (JP)

(73) Assignee: Murata Manufacturing Co., Ltd., Kyoto (JP)

(21) Appl. No.: 15/712,359

(22) Filed: Sep. 22, 2017

Related U.S. Application Data
(63) Continuation of application No. PCT/JP2016/056759, filed on Mar. 4, 2016.

(30) Foreign Application Priority Data
Mar. 27, 2015 (JP) 2015-065806

(51) Int. Cl. H01F 5/00; H01F 37/00

(52) U.S. Cl. CPC H01F 5/003; H01F 37/00

(57) ABSTRACT

A laminated electronic component in which magnetic body layers and conductor patterns are laminated, and the conductor patterns between the magnetic body layers are connected to form a coil within a laminated body. The magnetic body layers are formed from a metal magnetic body. At least one lead-out conductor pattern of the coil is connected with an external terminal formed on an undersurface of the laminated body through a conductor formed at a corner of the laminated body.

### CROSS REFERENCE TO RELATED APPLICATIONS

This application claims benefit of priority to Japanese Patent Application 2015-065806 filed Mar. 27, 2015, and the International Application PCT/JP2016/056759 filed Mar. 4, 2016, the entire content of which is incorporated herein by reference.

### TECHINICAL FIELD

The present disclosure relates to a laminated electronic component including magnetic body layers and conductor patterns being laminated, and a coil formed in the laminated body by connecting the conductor patterns between the magnetic body layers.

### BACKGROUND

As shown in FIGS. 5 and 6, some conventional laminated electronic components include magnetic body layers 51A to 51D and conductor patterns 52A to 52C being laminated, and the conductor patterns 52A to 52C between the magnetic body layers being spirally connected to form a coil within the laminated body, wherein the lead ends of the coil are led to end faces of the laminated body to connect the coil with external terminals 55, 56 formed on the surfaces including the end faces and the four surfaces adjacent to the end faces of the laminated body.

Recent mobile devices are increasingly downsized and have higher functions. Along with this, inductors to be used in power supply circuits for such mobile devices are required to be smaller and thinner. Amid such tendencies, these mobile devices now operate at increasingly lower voltage levels, and DC-superposition characteristic of such inductors are thus required to be further improved.

One method of improving DC-superposition characteristics may use a material having a high maximum magnetic flux density for a magnetic body to be included in the elemental assembly of an inductor. Although conventional laminated electronic components typically include a laminated body formed from ferrite, the maximum magnetic flux density of ferrite is as low as 0.4 T. Thus, conventional laminated electronic components tend to be magnetically saturated when a high current is applied.

To solve such a problem, the material for the laminated body can be changed from ferrite to a metal magnetic body with high saturated magnetic flux density to improve DC-superposition characteristics (e.g., refer to Japanese Unexamined Patent Application Publication No. 2013-45985). However, such a conventional laminated electronic component has a metal magnetic body in the laminated body with a withstanding voltage as small as several hundred V/mm compared with the withstanding voltage of ferrite of several kV/mm. Thus, the withstanding voltage of such a laminated body is smaller than that of a laminated body formed from ferrite at a portion where the electric potential difference between an external terminal and a conductor pattern is large, at a portion where the distance between an external terminal and a conductor pattern is small, and at a portion where the distance between one external terminal and the other external terminal is small in the laminated body.

In a conventional laminated electronic component, external terminals are formed on its end faces and four surfaces adjacent to the end faces. In addition, the distance between the external terminals and the conductor patterns tends to be small because of, for example, misalignment of the printing position or bleeding of the printing of the conductor patterns, or misalignment of the cutting position of the laminated body. These structural variations may cause significant variations in withstanding voltage characteristics, or even breakage of the product when a high voltage is applied. To solve such a problem, the surface of the laminated body including a coil inside can be covered with, for example, ceramics with high withstanding voltage to improve withstanding voltage (e.g., refer to Japanese Patent Publication No. 5190331).

However, covering the surface of the laminated body with, for example, ceramics in conventional laminated electronic components necessitates reduction by that much of the volume of the laminated body or the cross-sectional area of the core of the coil. Thus, the intended inductance or superior DC-superposition characteristics cannot be achieved.

### SUMMARY

One or more embodiments of the present disclosure provide a laminated electronic component with superior DC-superposition characteristics and improved withstanding voltage characteristics, without reducing the volume of the laminated body or the cross-sectional area of the core of the coil.

According to one or more embodiments of the present disclosure, in a laminated electronic component in which magnetic body layers and conductor patterns are laminated and the conductor patterns between the magnetic body layers are connected to form a coil within the laminated body, the magnetic body layers are formed from a metal magnetic body, and at least one lead-out conductor pattern of the coil is connected with an external terminal formed on an undersurface of the laminated body through a conductor formed at a corner of the laminated body.

According to the one or more embodiments of the present disclosure, in a laminated electronic component in which magnetic body layers and conductor patterns are laminated and the conductor patterns between the magnetic body layers are connected to form a coil within the laminated body, the magnetic body layers are formed from a metal magnetic body, and at least one lead-out conductor pattern of the coil is connected with an external terminal formed on an undersurface of the laminated body through a conductor formed at a corner of the laminated body. Thus, the laminated electronic component has superior DC-superposition characteristics and improved withstanding voltage characteristics.

### BRIEF DESCRIPTION OF THE DRAWINGS

FIG. 1 is an exploded perspective view of a laminated electronic component according to a first embodiment of the present disclosure.

FIG. 2 is a perspective view of a laminated electronic component according to the first embodiment of the present disclosure.

FIG. 3 is an exploded perspective view of a laminated electronic component according to a second embodiment of the present disclosure.

FIG. 4 is a perspective view of a laminated electronic component according to the second embodiment of the present disclosure.

FIG. 5 is an exploded perspective view of a conventional laminated electronic component.

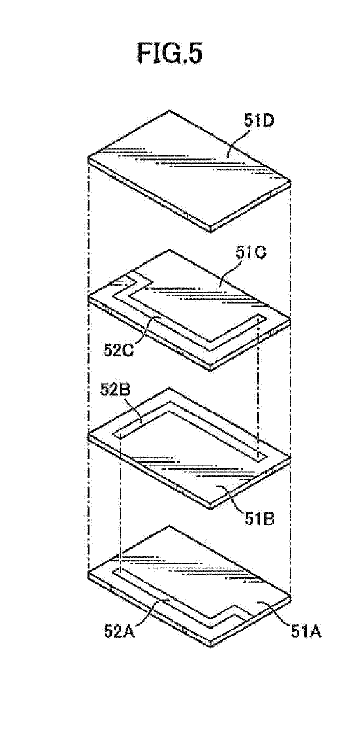

FIG. 6 is a perspective view of the conventional laminated electronic component.

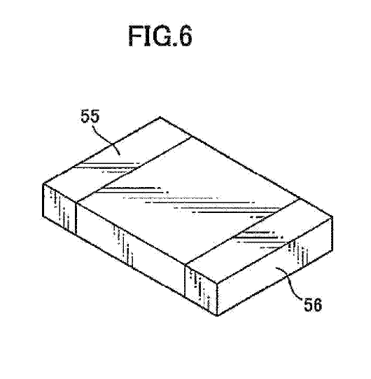

### DETAILED DESCRIPTION

In the one or more embodiments of the present disclosure, magnetic body layers and conductor patterns are laminated, and the conductor patterns between the magnetic body layers are connected to form a coil within the laminated body. The magnetic body layers are formed from a metal magnetic material. The coil has at least one lead-out conductor pattern led out to a corner of the magnetic body layers, and connected with a conductor extending at a corner of the laminated body from the undersurface of the laminated body in the laminated direction of the magnetic body layer. The undersurface of the conductor is connected with an external terminal formed only on the undersurface of the laminated body.

Thus, the one or more embodiments of the present disclosure can have a larger distance of the portion where the electric potential difference between an external terminal and a conductor pattern is larger in the laminated body than conventional laminated electric components. Also, the conductors for connecting the lead-out conductor patterns and the external terminals of the coil are arranged in an area where the magnetic flux density generated by the coil is low. This structure can minimize the area occupied by the conductors in the laminated body.

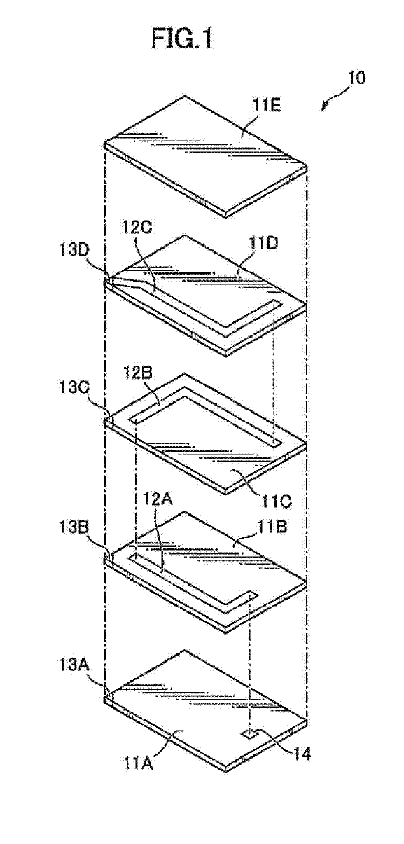

The best mode for carrying out the present disclosure will now be described with reference to FIGS. 1 to 4.

FIG. 1 is an exploded perspective view of a laminated electronic component according to a first embodiment of the present disclosure. In FIG. 1, the reference symbol 10 denotes a laminated body, the reference symbols 11A to 11E denote magnetic body layers, and the reference symbols 12A to 12C denote conductor patterns.

The laminated body 10 is formed by laminating magnetic body layers 11A to 11E and conductor patterns 12A to 12C. The magnetic body layers 11A to 11E are formed using a metal magnetic body formed from, for example, powder of a metal magnetic alloy containing iron and silicon, powder of a metal magnetic alloy containing iron, silicon, and chromium, or powder of a metal magnetic alloy containing iron, silicon, and an element that is more easily oxidized than iron. The conductor patterns 12A to 12C are formed from a conductor paste of a metal material, such as a silver, silver-base, gold, gold-base, copper, or copper-base metal material.

The magnetic body layer 11A is formed in the shape of a rectangular sheet, and a notch is formed at one corner of the four corners when viewed from the top surface, and a through-hole is formed at a position corresponding to an end of a later-described conductor pattern. In the notch formed at one corner of the magnetic body layer 11A, a conductor 13A having the same thickness as the magnetic body layer 11A is formed in a manner to fill the corner of the magnetic body layer 11A. Further, in the through-hole of the magnetic body 11A, a conductor 14 having the same thickness as the magnetic body layer 11A is formed. The conductor 13A and the conductor 14 are formed by printing using the same material as the conductor pattern.

The magnetic body layer 11B is formed in the shape of a rectangular sheet, and a notch is formed at a position corresponding to the notch formed at the corner of the magnetic body layer 11A. On the top surface of the magnetic body layer 11B, a conductor pattern 12A is formed. The conductor pattern 12A is formed in a length less than one turn, and one end of the conductor pattern 12A is connected with the conductor 14 through a conductor formed in a through-hole of the magnetic body layer 11B. In the notch formed at one corner of the magnetic body layer 11B, a conductor 13B having the same thickness as the magnetic body layer 11B is formed in a manner to fill the corner of the magnetic body layer 11B. The conductor 13B is formed by printing using the same material as the conductor pattern 12A.

The magnetic body layer 11C is formed in the shape of a rectangular sheet, and a notch is formed at a position corresponding to the notch formed at the corner of the magnetic body layer 11B. On the top surface of the magnetic body layer 11C, a conductor pattern 12B is formed. The conductor pattern 12B is formed in a length less than one turn, and one end of the conductor pattern 12B is connected with the other end of the conductor pattern 12A through a conductor formed in a through-hole of the magnetic body layer 11C. In the notch formed at one corner of the magnetic body layer 11C, a conductor 13C having the same thickness as the magnetic body layer 11C is formed in a manner to fill the corner of the magnetic body layer 11C. The conductor 13C is formed by printing using the same material as the conductor pattern 12B.

The magnetic body layer 11D is formed in the shape of a rectangular sheet, and a notch is formed at a position corresponding to the notch formed at the corner of the magnetic body layer 11C. On the top surface of the magnetic body layer 11D, a conductor pattern 12C is formed. The conductor pattern 12C is formed in a length less than one turn, and one end of the conductor pattern 12C is connected with the other end of the conductor pattern 12B through a conductor formed in a through-hole of the magnetic body layer 11D, and the other end of the conductor pattern 12C is led out to the notch formed at the corner of the magnetic body layer 11D. In the notch formed at one corner of the magnetic body layer 11D, a conductor 13D having the same thickness as the magnetic body layer 11D is formed in a manner to fill the corner of the magnetic body layer 11D, and is connected with the other end of the conductor pattern 12C. The conductor 13D is formed by printing using the same material as the conductor pattern 12C.

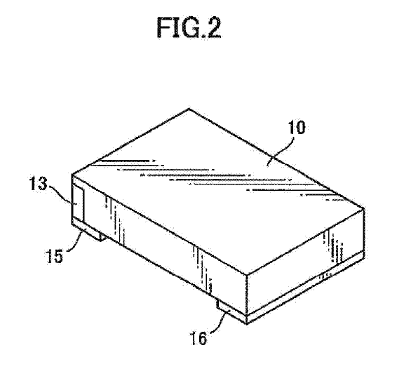

Over the insulator layer 11D, on which the conductor pattern 12C is formed, a magnetic body layer 11E for protecting the conductor patterns is formed. In this manner, connecting spirally the conductor patterns 12A to 12C between the magnetic body layers forms a coil pattern in the laminated body. In the laminated body 10, the conductor with which one lead end of the coil pattern is connected is exposed on the undersurface, and as shown in FIG. 2, a conductor 13 in which the conductors 13A to 13D are laminated and with which the other lead end of the coil pattern is connected is exposed at a corner of the laminated body 10. At this time, the conductor 13 extends from the undersurface of the laminated body 10 in the laminated direction of the magnetic body layers in a manner not to expose its top surface on the top surface of the laminated body 10. Further, on the undersurface of the laminated body 10, external terminals 15, 16 are formed. The conductor 13 exposed on the undersurface of the laminated body 10 is connected with the external terminal 15, and the conductor 14 exposed on the undersurface of the laminated body 10 is connected with the external terminal 16.

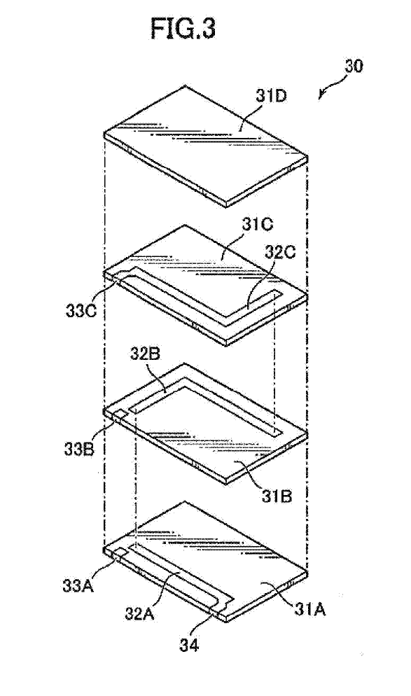

FIG. 3 is an exploded perspective view of a laminated electronic component according to a second embodiment of the present disclosure. A magnetic body layer 31A is formed in the shape of a rectangular sheet, and grooves are formed at two positions corresponding to corner portions, when viewed from the top surface, of one side of the magnetic body layer 31A. On the top surface of the magnetic body layer 31A, a conductor pattern 32A is formed. The conductor pattern 32A is formed in a length less than one turn. In the grooves formed on one side of the magnetic body layer 31A, conductors 33A and 34 having the same thickness as the magnetic body layer 31A are formed, and one end of the conductor pattern 32A is connected with the conductor 34. The conductors 33A and 34 are formed by printing using the same material as the conductor pattern 32A.

The magnetic body layer 31B is formed in the shape of a rectangular sheet, and a groove is formed at a position corresponding to the conductor 33A formed on one side of the magnetic body layer 31A. On the top surface of the magnetic body layer 31B, a conductor pattern 32B is formed. The conductor pattern 32B is formed in a length less than one turn, and one end of the conductor pattern 32B is connected with the other end of the conductor pattern 32A through a conductor in a through-hole formed in the magnetic body layer 31B. In the groove formed on one side of the magnetic body layer 31B, a conductor 33B is formed. The conductor 33B is formed by printing using the same material as the conductor pattern 32B.

The magnetic body layer 31C is formed in the shape of a rectangular sheet, and a groove is formed at a position corresponding to the conductor 33B formed on one side of the magnetic body layer 31B. On the top surface of the magnetic body layer 31C, a conductor pattern 32C is formed. The conductor pattern 32C is formed in a length less than one turn, and one end of the conductor pattern 32C is connected with the other end of the conductor pattern 32B through a conductor formed in a through-hole of the magnetic body layer 31C, and the other end of the conductor pattern 32C is led out to the groove of the magnetic body layer 31C. In the groove formed on the magnetic body layer 31C, a conductor 33C having the same thickness as the magnetic body layer 31C is formed and connected with the other end of the conductive pattern 32C. The conductor 33C is formed by printing using the same material as the conductor pattern 32C.

Over the insulator layer 31C, on which the conductor pattern 32C is formed, a magnetic body layer 31D for protecting the conductor patterns is formed. In this manner, connecting spirally the conductor patterns 32A to 32C between the magnetic body layers forms a coil pattern in the laminated body.

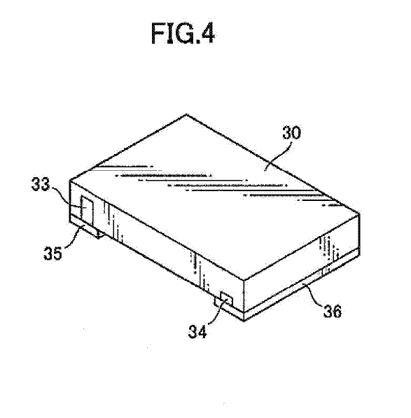

In the laminated body 30, as shown in FIG. 4, a conductor 33 extending from the undersurface of the laminated body 30 in the laminated direction of the magnetic body layers and with which a lead end of the coil pattern is connected, and a conductor 34 with which the other lead end of the coil pattern is connected are exposed at positions corresponding to corner positions on one side of the laminated body 30. At this time, the top surface of the conductor 33 and the top surface of the conductor 34 are formed in a manner not to be exposed from the top surface of the laminated body 30. Further, on the undersurface of the laminated body 30, external terminals 35, 36 are formed. The conductor 33 exposed on the undersurface of the laminated body 30 is connected with the external terminal 35, and the conductor 34 exposed on the undersurface of the laminated body 30 is connected with the external terminal 36.

Both of the lead out ends of the coil pattern of the thus formed laminated electronic component are connected with the external terminals formed on the undersurface of the laminated body through the conductors formed at the corners of the laminated body. This structure allows both conductors to be arranged at a portion where the magnetic flux density generated by the coil is low, and thus the portion with high magnetic flux density generated by the coil can be more effectively utilized compared with the previous example.

Although some embodiments of the laminated electronic component according to the present disclosure are described above, the present disclosure is not limited to these embodiments. For example, in the first embodiment, a notch may be provided in the magnetic body layer 11B at one corner of the four corners when viewed from the top surface, and a groove passing through the top surface to the undersurface may be provided at one end face of the magnetic body layer 11B. A conductor having the same thickness as the magnetic body layer 11B may then be formed in the notch and the groove, and one end of the conductor pattern 12A may be connected with the conductor formed in the groove.

In this case, the magnetic body layer 11A needs not be provided, and the conductor provided in the groove is exposed across the undersurface and the end face of the laminated body.

Further, in the second embodiment, a magnetic body layer having grooves formed at positions corresponding to the conductors 33A, 34 formed on one side of the magnetic body layer 31A may be arranged in an under layer of the magnetic body layer 31A, and a conductor having the same thickness as the magnetic body layer may be formed in each groove. Further, the magnetic body layers may be formed by adding glass to metal magnetic body particles, or adding an element that is more easily oxidized than iron to powder of a metal magnetic alloy containing iron and silicon, or powder of a metal magnetic alloy containing iron, silicon, and chromium. At this time, multiple types of glasses or elements that are more easily oxidized than iron may be added.

Further, in a laminated electronic component having a margin in the volume of the laminated body, the conductors connecting the lead ends of the coil patterns and the external terminals on the undersurface of the laminated body may be buried in the corners of the laminated body so that its side surfaces are not exposed on the surfaces of the laminated body.

1. A laminated electronic component comprising
magnetic body layers, and
conductor patterns laminated to the magnetic body layers, the conductor patterns between the magnetic body layers being connected to form a coil within a laminated body,
wherein the magnetic body layers are formed from a metal magnetic body, and at least one lead-out conductor pattern of the coil is connected with an external terminal formed on an undersurface of the laminated body through a conductor formed at a corner of the laminated body.

2. The laminated electronic component according to claim 1, wherein another lead-out conductor pattern of the coil is also connected with an external terminal formed on the undersurface of the laminated body through a conductor formed at a corner of the laminated body.

3. The laminated electronic component according to claim 1, wherein the conductor is formed by printing a conductor passing through an insulator layer at a corner of the insulator layer.

4. The laminated electronic component according to claim 2, wherein the conductor is formed by printing a conductor passing through an insulator layer at a corner of the insulator layer.

5. The laminated electronic component according to claim 1, wherein the conductor is exposed on a surface of the laminated body.

6. The laminated electronic component according to claim 2, wherein the conductor is exposed on a surface of the laminated body.

7. The laminated electronic component according to claim 3, wherein the conductor is exposed on a surface of the laminated body.

8. The laminated electronic component according to claim 4, wherein the conductor is exposed on a surface of the laminated body.

9. The laminated electronic component according to claim 1, wherein the conductor is buried in a corner of the laminated body.

10. The laminated electronic component according to claim 2, wherein the conductor is buried in a corner of the laminated body.

11. The laminated electronic component according to claim 3, wherein the conductor is buried in a corner of the laminated body.

12. The laminated electronic component according to claim 4, wherein the conductor is buried in a corner of the laminated body.
